(19) United States
(12) Patent Application Publication
(10) Pub. No.: US 2003/0127008 A1
(43) Pub. Date: Jul. 10, 2003

(54) Method of generating a graphic image on fabric and a graphic product generated

(76) Inventor: Stephane Smith, Vernon, CT (US)

Correspondence Address: McCormick Paulding & Huber LLP, City Place II, 185 Asylum Street, Hartford, CT, 06103, US

(21) Appl. No.: 09/576,827

(22) Filed: May 23, 2000

(51) Int. Cl. B41F 23/04

(52) U.S. Cl. 101/487

(57) ABSTRACT

A method of generating a graphic on fabric includes providing a sheet of heat settable adhesive, preferably a clear urethane heat transfer adhesive, having first and second oppositely facing surfaces. The second surface is supported on a sheet of backing material. Ink forming a graphic is applied to the first surface of the adhesive. Unused adhesive, if any, adjacent to the graphic is removed if necessary or desired. The adhesive carrying the graphic is placed into contact with the fabric, and the adhesive carrying the graphic is heated above a setting temperature of the adhesive while in contact with the fabric so as to permanently affix the graphic to the fabric.

### FIELD OF THE INVENTION

The present invention relates generally to a method of generating graphics on a product and the product generated, and more particularly to a method of generating a graphic on fabric by means including a thermal transfer printer.

### BACKGROUND OF THE INVENTION

It has been common practice to print graphics on fabric by means of a screen printing process. In such a process, the fabric is placed on a printing press which includes a printing screen having a pattern of open and closed pores defining the graphic to be printed. The graphic is printed by placing the screen over the fabric and forcing ink through the open pores by means of a roller or squeegee. The screen printing process as typically practiced by those skilled in the art is time consuming, labor intensive and expensive. First, the graphic to be printed must be formed on the screen, usually as a positive. The screen is coated with a photographic emulsion, and a transparent sheet bearing the graphic is placed over the emulsion. The areas of emulsion not covered by the graphic are then hardened by exposing the emulsion to light directed through the transparent sheet. Exposing the photographic emulsion in this manner permanently closes the pores in the portion of the screen not covered by the graphic. The unexposed areas of the emulsion are subsequently washed off of the screen to provide an area of open pores which, in conjunction with an adjoining area of closed pores, define the graphic to be printed.

Each time a new graphic is to be printed, a new screen bearing the desired artwork must be prepared. Moreover, prior to printing, the graphic must be precisely located with respect to both the printing screen and the printing press to insure that the printed graphic is properly positioned on the fabric. The time, labor and expense of preparing the printing screen and properly positioning the graphic is particularly critical when printing a multi-color graphic on fabric. In such a case, a number of printing screens, one for each color, must be prepared, and great care must be taken to insure that the graphic on the screen for each individual color precisely registers with the graphic on the screens for the other colors.

U.S. Pat. No. 5,156,089, assigned to the same assignee as is the present invention, discloses a method and apparatus for preparing a printing screen using printing technology. According to this reference, a screen having a photographic emulsion applied to one surface thereof is supported in a printing mechanism capable of movement along X, Y and Z printing axes. The screen is oriented with respect to the printing axes, and a selected location on the screen is aligned with a selected coordinate position on the printing axes.

The printing mechanism is provided with data defining the color separations for the graphic to be printed directly on the emulsion layers of the screens, data defining the dimensions of the screens, and data defining selected coordinates within the dimensions of the screens with which corresponding reference coordinates of the graphic are to register when the graphic is printed on the emulsion layers. A graphic for one color is printed directly on an emulsion layer according to the data provided, and after the printing operation is complete, the emulsion layer is exposed using the printed graphic as an exposure mask. The screen is then washed to remove the unexposed portions of the emulsion together with the printed graphic to leave a pattern of open and closed pores on the screen defining the graphic.

The method and apparatus disclosed by the referenced patent permit the graphic to be precisely and automatically located with respect to the printing screen. While this significantly reduces the time and effort required to properly align the screen in the printing press, it does not eliminate the need to first prepare a printing screen, mount the screen in the printing press and then force ink through the open pores of the screen to print the graphic on fabric.

Graphics have also been printed on fabric using a thermal transfer process. In such a process a thermal transfer ribbon, including a layer of ink dispersed in a wax, resin or wax-resin vehicle is used to print the desired graphic onto a thermally stable substrate, such as thermal paper, coated with a resin binder. The printed paper is then placed print side down on the fabric, and the ink is transferred to the fabric in a press by the application of heat and pressure. The resin binder is also transferred, and the resin binds the ink to the fabric.

Generally, the printed graphic is defined by one or more print areas covered by the ink and adjacent “white” or non-print areas. However, since the entire surface of the thermal paper is coated with the binder, binder transfers to the fabric throughout this adjacent, non-print area, as well as in the areas covered by the ink. The binder gives the non-print areas of the fabric an undesirable hue or texture and also seals the fabric weave together, which prevents the free passage of air and moisture through the fabric in the non-print areas. Further, the resin binder is not transparent and leaves a shadow around the graphic. The resin shadow is particularly noticeable on colors other than white. Thus, the above-described method of printing is generally limited to use with white fabrics.

In view of the foregoing, it is an object of the present invention to provide a method for generating graphics on fabric which requires less labor and equipment than screen printing.

It is a further object of the present invention to provide a method for generating graphics on fabric which does not leave a resin shadow on the fabric receiving the graphic.

Other objects and advantages will be apparent from the following description and accompanying drawings.

### SUMMARY OF THE INVENTION

In one aspect of the present invention, a method of generating a graphic on fabric includes providing a sheet of heat settable adhesive having first and second oppositely facing surfaces. Preferably the adhesive is a clear urethane heat transfer adhesive. The second surface is supported on a sheet of backing material. Ink forming a graphic is applied to the first surface of the adhesive. Unused adhesive, if any, adjacent to the graphic is removed if necessary or desired. The adhesive carrying the graphic is placed into contact with the fabric, and the adhesive carrying the graphic is heated above a setting temperature of the adhesive while in contact with the fabric so as to permanently affix the graphic to the fabric.

In another aspect of the present invention, a fabric product having a graphic affixed thereon is made in accordance with the claimed method of the present invention.

An advantage of the present invention is that a graphic is generated on fabric without the time, labor and expense required for screen printing the graphic.

A second advantage of the present invention is that the graphic can be encapsulated between fabric and a clear adhesive such that the graphic is protected against deterioration resulting from wear, cleaning and otherwise aging.

A third advantage is that the graphic product made in accordance with the present invention does not have a resin shadow causing an unsightly appearance.

### BRIEF DESCRIPTION OF THE DRAWINGS

FIG. 1 schematically illustrates a system for printing and cutting graphics in accordance with the present invention.

FIG. 2 schematically illustrates a side view of a thermal printer for use in the system shown in FIG. 1.

FIG. 3 is a schematic, top plan view of a reverse graphic image created by the thermal printer of FIG. 2 penetrating into clear urethane adhesive supported on backing material.

FIG. 4 is a schematic, side elevational view of the graphic image of FIG. 3.

FIG. 5 is a schematic, side elevational view of a graphic image in accordance with a further embodiment.

FIG. 6 schematically illustrates the graphic image of FIG. 3 upon being affixed to piece of fabric in the form of a T-shirt.

FIG. 7 is a flow diagram illustrating the steps of forming a graphic on fabric in accordance with an embodiment of the present invention.

FIG. 8 is a flow diagram illustrating the steps of forming a graphic on fabric in accordance with another embodiment of the present invention.

### DETAILED DESCRIPTION OF THE PREFERRED EMBODIMENTS

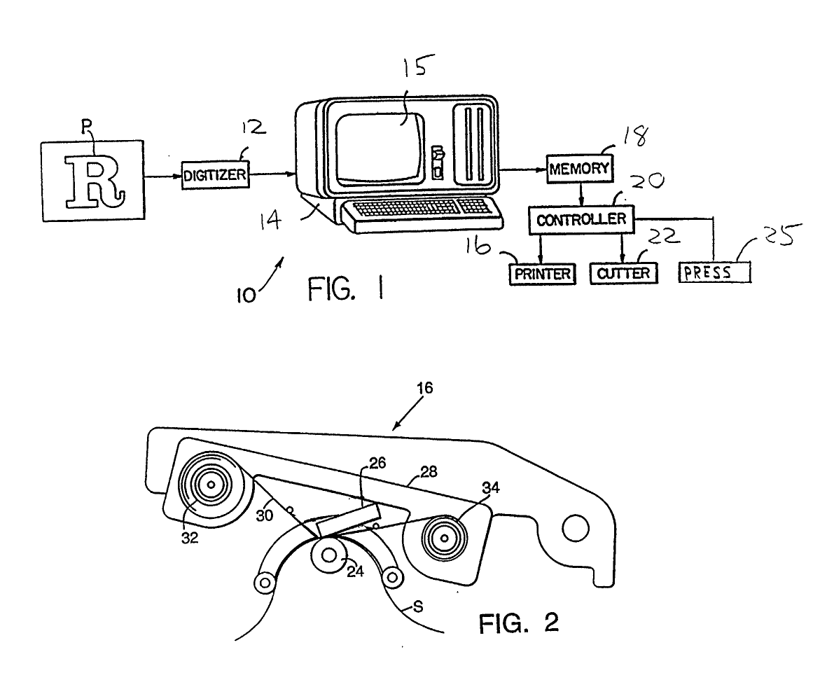

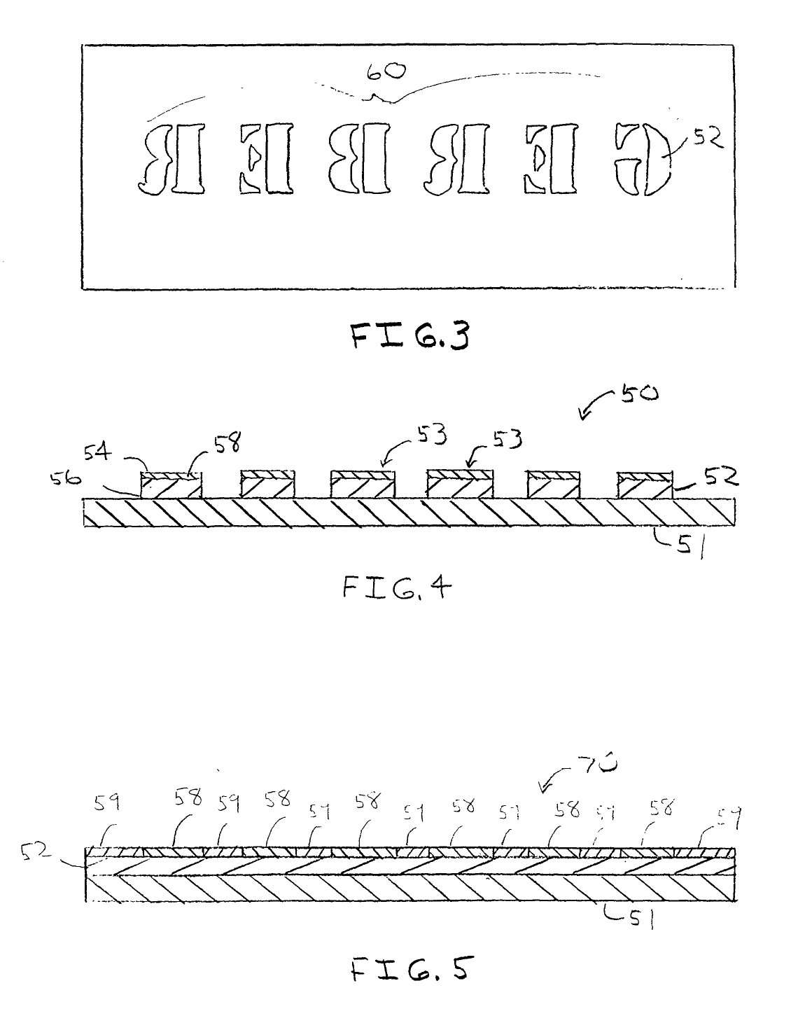

With reference to FIGS. 1 and 2, an example of a system for generating graphics on fabric in accordance with the present invention is generally designated by the reference number 10. The system 10 to be described hereinbelow is one possible system for generating graphics on fabric in accordance with the present invention, and is therefore shown by way of illustration rather than limitation.

The system 10, as described more fully in U.S. Pat. Nos. 5,598,202 and 5,537,135, preferably includes a digitizer 12 or other data input device which supplies a computer 14 with machine readable data defining the graphic to be printed. From the data defining the graphic, the computer 14 generates a printing program for operating a thermal printer 16 that prints the graphic on a sheet of adhesive, preferably a clear urethane adhesive sheet supported on a backing material, as will be described more fully with reference to FIGS. 3-5. In the preferred embodiment, a clear sheet of urethane heat settable transfer adhesive #9625 manufactured by Bemis Corporation of Shirley, Mass. is employed. The heat transfer adhesive is conventionally used to provide non-stitched seams to fabrics. This adhesive is preferred because, among other things, the urethane heat transfer adhesive does not become yellow after being heated and is dry cleanable. However, other heat transfer or urethane adhesives may be used to practice the invention. Testing indicates that the preferred adhesive attaches well to cotton and cotton polyester blends, and the inventor contemplates use with wool, nylon and other synthetic fabrics.

The printing program is stored in memory 18, and when the graphic is to be printed, a controller 20 reads the program and operates the thermal printer 16. From the data defining the graphic, the computer 14 also generates a cutting program for operating a cutter 22 that may cut the peripheral edges of the graphic and any internal edges of the graphic in accordance with a cutting program in the memory 18 in order to facilitate removal of an unused portion or weed, if any, from the graphic if such removal is necessary or desired. Once the graphic has been printed and any weed has been removed, the graphic carried by the adhesive is transferred from the backing material to fabric and affixed permanently to the fabric by, for example, a heat press 25 as will be explained more fully hereinbelow.

The computer 14 displays the machine readable data defining the graphic as an image on screen or monitor 15. The memory 18 may also include graphics in which case the data input to the computer 14 for the purposes of preparing a final product may be selected entirely from the memory 16. Still further, the digitizer 12 may serve as the sole input device and may provide the critical data points defining the edges of the graphics to be cut as well as the edges of the graphics for a printing operation. Still other data sources may be employed to supply the computer 14 with an infinite variety of graphic images.

A thermal printer useful in practicing the invention is illustrated schematically in FIG. 2. The printer, generally designated 16, includes a roller platen 24 over which a thermally stable substrate or backing material carrying the clear adhesive sheet passes relative to a thermal print head 26. The substrate S is supplied in sheet or strip form. As the backing material and adhesive sheet carried thereon pass over the platen 24, the print head 26 is pressed downwardly onto the adhesive and generally establishes a linear zone of contact between the adhesive and the platen. A cassette 28 supplies a thermal transfer ribbon 30 which carries an ink resin which may be of any color including black and white. Preferably, the ink resin is attached to a plasticizer and is carried on a thermal transfer foil or ribbon, the thermal transfer foil and ink resin available, for example, by manufacturer Kurz Hastings of Germany. The ribbon 30 extends from a supply roll 32, between the print head 26 and the platen 24, to a take-up roll 34 of the cassette 28. Thus, as the print head 26 presses down on the platen 24 with the adhesive and ribbon 30 interposed therebetween, the ink carried by the ribbon is transferred to the adhesive according to the data defining the graphic.

A more complete description of the printer 16 may be found in U.S. Pat. No. 5,537,135, the disclosure of which is incorporated herein by reference. It should be understood, however, that the present invention is in no way limited in this regard and that any one of a wide variety of thermal printers already known to those skilled in the art may be substituted.

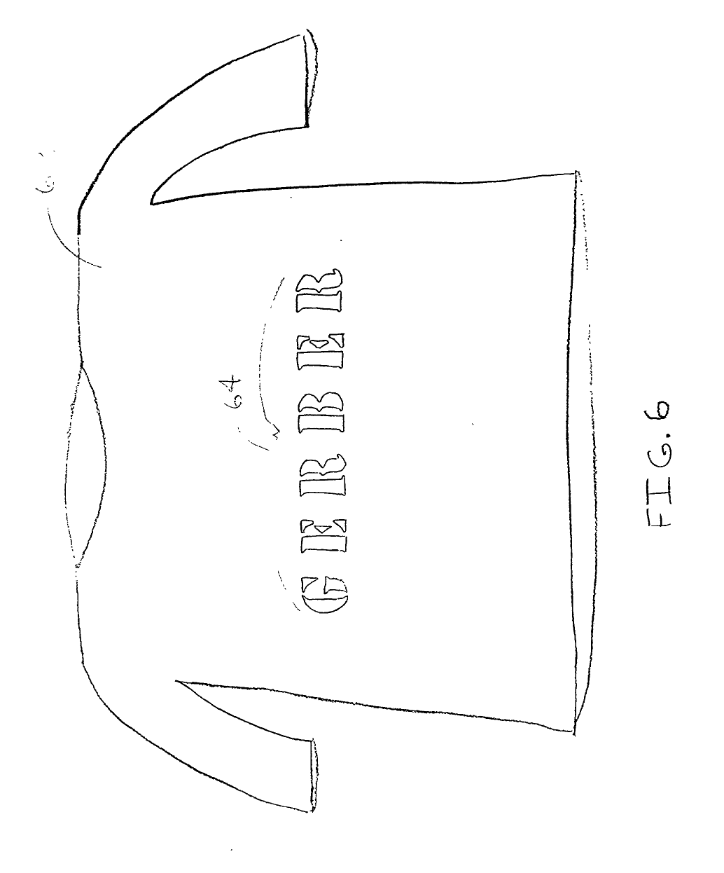

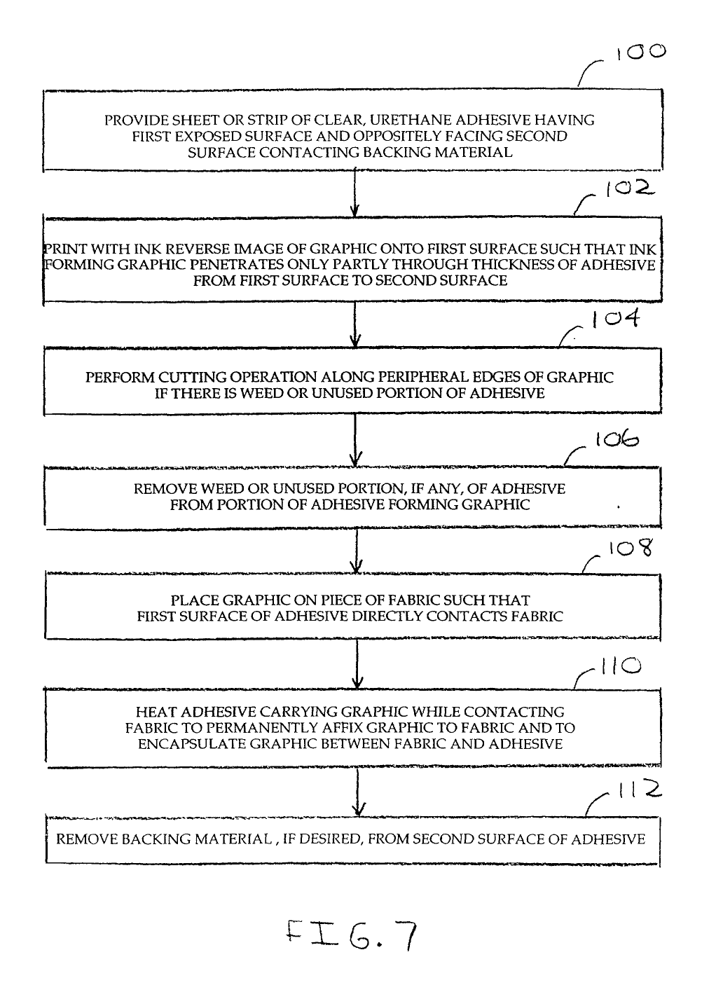

An example of a graphic 50 generated on adhesive is shown with reference to FIGS. 3 and 4. A thermally stable backing material 51 carries a sheet of clear adhesive 52, preferably a urethane adhesive. The backing material 51 preferably includes a silicone surface to facilitate removal of the adhesive 52 therefrom. The sheet of adhesive 52 is shown as a plurality of components 53, 53 after a weeding operation to remove any unused adhesive between the components. The sheet of adhesive 52 has first and second oppositely facing surfaces 54 and 56, respectively. As shown in FIG. 4, the first surface 54 receives an ink 58, such as an ink resin, to define the graphic 50 during a printing operation. Preferably, the ink 58 penetrates only partly through a thickness of the adhesive 52 from the first surface 54 to the second surface 56 for reasons to be explained hereinbelow. As shown by way of example in FIG. 3, the graphic 50 printed on the adhesive 52 is a reverse image 60 of the word “GERBER” which may be transferred to a piece of fabric 62, as shown in FIG. 6, in such a way that a front image 64 of the graphic faces outwardly from the fabric.

FIG. 5 illustrates another embodiment of a graphic 70 in accordance with the present invention. Like elements with the graphic 50 of FIG. 4 are labelled with like reference numbers. The graphic 70 is similar to the graphic 50 of FIG. 4 except a first ink 58 having a first color and a second ink 59 having a second color are received by the sheet of adhesive 52. The first ink 58, for example, forms the letters of the word “GERBER”, as shown in FIG. 3, and the second ink 59 forms a background color. For example, the ink 58 defining the letters “GERBER” might be black, and the ink 59 forming the background might be yellow in order to make the lettering “GERBER” stand out more boldly. Of course, other combinations of colors may be used for practical or aesthetic purposes, and the number of different colors need not be limited. Because the graphic 70 uses both the lettering “GERBER” and a background color to form the graphic, no weeding is necessary or desired for the graphic.

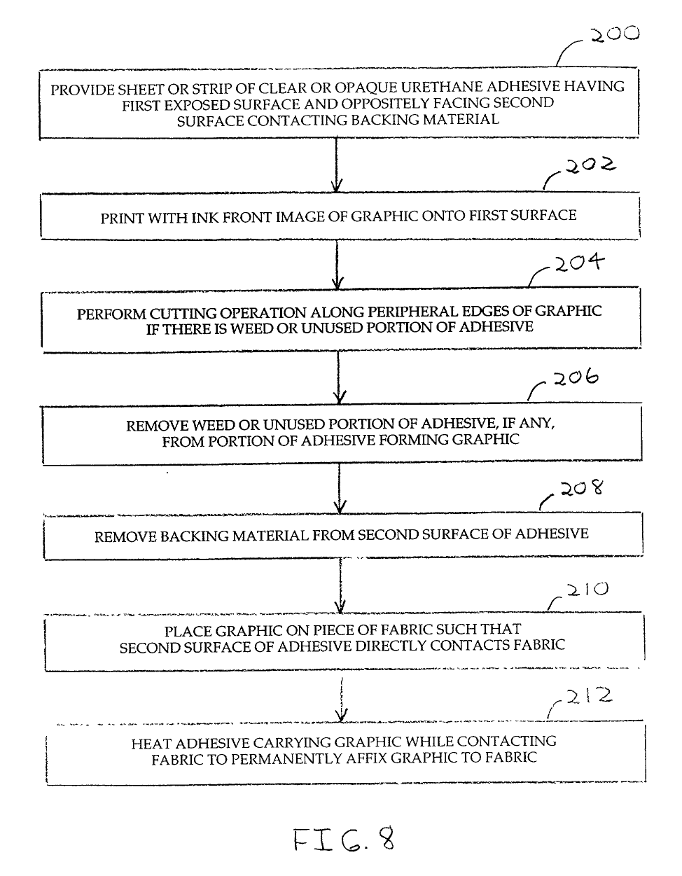

A most preferred embodiment of a process for generating a graphic image on fabric is described in the flow diagram of FIG. 7. In operation, a sheet or strip of clear, urethane adhesive is provided. The adhesive has a first exposed surface and an oppositely facing second surface contacting backing material (step 100). Preferably, a urethane heat transfer adhesive of about 4 mils in thickness and supported on a silicone backing material, part #9625 by Bemis Corp. of Shirley, Mass., is used. However, other types of heat transfer or urethane adhesives may be substituted without departing from the scope of the invention. A print operation uses one or more inks of various colors including black and white to form a reverse graphic image onto the first surface of the adhesive such that the ink penetrates only partly through the thickness of the adhesive from the first surface to the second surface of the adhesive (step 102). A cutting operation is performed along peripheral edges of the graphic if there is weed or an unused portion of adhesive to be discarded (step 104). Any such weed or unused portion of adhesive is separated from the portion of adhesive forming the graphic (step 106). The graphic is placed on a piece of fabric such that the first surface of the adhesive carrying the graphic directly contacts the fabric (step 108), whereby a front image of the graphic faces outwardly from the fabric.

The backing material maintains the spacing among any separate components forming the graphic such as the letters forming the graphic “GERBER”. The adhesive carrying the graphic while contacting the fabric is heated, for example, in a heat press to permanently affix the graphic to the fabric (step 110). The adhesive is heated in the range of about 250° F. to 385° F., and preferably to about 275° F. for about 15-20 seconds to permanently affix the adhesive to the fabric. Applying too much heat may cause the ink resin carried by the urethane adhesive to bleed. For best results, the adhesive should be allowed to cool for the adhesive to set up.

Because the ink penetrates only partly through the thickness of the adhesive, the graphic when affixed to the fabric becomes encapsulated between the fabric and the adhesive so as to protect the graphic against deterioration resulting from wear, cleaning and otherwise aging. The backing material may then be removed from the second surface of the adhesive (step 112).

Another process for generating a graphic onto a piece of fabric is described in the flow diagram of FIG. 8. In operation, a sheet or strip of clear or opaque urethane adhesive is provided. The adhesive has a first exposed surface and an oppositely facing second surface contacting backing material (step 200). A print operation uses one or more inks of various colors including black and white to form a front graphic image onto the first surface of the adhesive (step 202). A cutting operation is performed along peripheral edges of the graphic if there is weed or an unused portion of adhesive to be discarded (step 204). Any such weed or unused portion of adhesive is removed from the portion of adhesive forming the graphic (step 206). The backing material is removed from the second surface of the adhesive (step 208). The graphic is placed on a piece of fabric such that the second surface of the adhesive carrying the graphic directly contacts the fabric, whereby the front image of the graphic faces outwardly from the fabric (step 210). The adhesive carrying the graphic while contacting the fabric is heated, for example, in a heat press to permanently affix the graphic to the fabric (step 212).

This process is less preferable than that described with reference to FIG. 7 because the backing material is removed before the graphic has been applied to the fabric, and thus the backing material is not present to maintain the spacing of any separate components forming the graphic upon application of the graphic to the fabric. Further, the graphic is not encapsulated between the fabric and adhesive, and consequently the exposed graphic is more susceptible to deterioration resulting from wear, cleaning and otherwise aging.

Although this invention has been shown and described with respect to exemplary embodiments thereof, it should be understood by those skilled in the art that the foregoing and various other changes, omissions, and additions in the form and detail thereof may be made therein without departing from the spirit and scope of the invention. Accordingly, the present invention has been shown and described in various embodiments by way of illustration rather than limitation.

What is claimed is:

1. A method of generating a graphic on fabric, comprising the steps of:
providing a sheet of heat settable adhesive having first and second oppositely facing surfaces;
applying inked graphic to the first surface of the sheet of adhesive;
placing the sheet of adhesive carrying the inked graphic into contact with a fabric; and
heating the sheet of adhesive carrying the graphic above a setting temperature of the adhesive while the sheet is in contact with the fabric to permanently affix the graphic to the fabric.

2. A method as defined in claim 1, wherein the step of applying inked graphic includes transferring at least one ink to the first surface of the adhesive by means of a thermal transfer printer.

3. A method as defined in claim 1, wherein the step of applying inked graphic includes generating a graphic on the first surface of the adhesive via the thermal transfer printer from digital information defining the graphic.

4. A method as defined in claim 1, wherein the sheet of adhesive includes a clear urethane adhesive.

5. A method as defined in claim 4, wherein the urethane adhesive has a thickness of about four mils.

6. A method as defined in claim 1, wherein the backing material includes a silicone surface to support the sheet of adhesive.

7. A method as defined in claim 1, wherein the step of applying inked graphic includes applying a reverse image of the graphic on the first surface of the adhesive, and the step of placing includes placing the first surface of the sheet of adhesive in direct contact with the fabric.

8. A method as defined in claim 7, wherein after the step of heating further including the step of removing the backing material from the adhesive affixed to the fabric.

9. A method as defined in claim 8, wherein the inked graphic penetrates only partly through a thickness of the sheet of adhesive from the first surface to the second surface such that the graphic is encapsulated between the fabric and the adhesive.

10. A method as defined in claim 1, wherein the step of applying inked graphic includes applying a front image of the graphic on the first surface of the sheet of adhesive, thereafter further includes the step of removing the backing material from the second surface of the sheet of adhesive, and the step of placing includes placing the second surface of the adhesive in direct contact with the fabric.

11. A method as defined in claim 1, wherein the step of heating includes heating the adhesive to about 250° F. to 385° F.

12. A method as defined in claim 1, wherein the step of heating includes heating the adhesive to about 275° F. for about 15 to 20 seconds.

13. A method as defined in claim 1, wherein the step of heating includes employing a heat press.

14. A fabric product having a graphic affixed thereon made in accordance with the method of claim 1.
